(19) United States
(12) Patent Application Publication
(10) Pub. No.: US 2020/0125970 A1
(43) Pub. Date: Apr. 23, 2020

(54) DEFECT FACTOR ESTIMATION DEVICE AND DEFECT FACTOR ESTIMATION METHOD

(71) Applicant: MITSUBISHI ELECTRIC CORPORATION, Tokyo (JP)

(72) Inventor: Yasuhiro TOYAMA, Tokyo (JP)

(73) Assignee: MITSUBISHI ELECTRIC CORPORATION, Tokyo (JP)

(21) Appl. No.: 16/474,260

(22) PCT Filed: Feb. 9, 2017
(86) PCT No.: PCT/JP2017/004731

§ 371 Date: Jun. 27, 2019

(51) Int. Cl. G06N 5/04; G06Q 50/04; G06Q 10/00; G06F 16/28; G06F 16/22

(52) U.S. Cl. CPC G06N 5/04; G06Q 50/04; G06F 16/2228; G06F 16/285; G06Q 10/20

(57) ABSTRACT

A defect factor estimation device according to the present invention includes: a data collecting unit for collecting category data of a device included in equipment; a correlation calculating unit for calculating a correlation index of data including the category data collected by the data collecting unit; a data extracting unit for extracting a combination of data including the category data as data related to a defect on the basis of a change in the correlation index calculated by the correlation calculating unit; and a causal relationship estimating unit for extracting data estimated to be a defect factor from data related to the data related to the defect. Such a configuration enables detection of defects which cannot be detected by the conventional technology.

### TECHNICAL FIELD

The present invention relates to a defect factor estimation device for estimating a defect factor by correlation analysis of data.

### BACKGROUND ART

It is useful to identify factors of defects and to predict occurrence of a defect in equipment such as manufacturing devices, elevators, air conditioners, and power plant equipment in order to improve the efficiency of maintenance work at the time of occurrence of defects such as failures and abnormality. For example, Patent Literature 1 discloses a method for identifying a parameter (hereinafter referred to as data item) of the cause of a defect in a case where time series data (hereinafter referred to as sensor data) obtained from a plurality of sensors is detected as an abnormality upon prediction of faults in a copying machine or the like. In Patent Literature 1, when a correlation coefficient of a data item set that is correlated in a normal state falls below a threshold value, an abnormality is detected, and the detected data item is identified as the causal data item in conjunction with a data item representing a tendency similar to that of the detected data item. Identification of a causal data item is allowed to be faster and more accurate by classifying all the data items into relevant data item groups in advance and searching only within a group to which the detected data item belongs upon identification of a causal data item.

### CITATION LIST

### Patent Literature

Patent Literature 1: JP 2013-41173 A

### SUMMARY OF INVENTION

### Technical Problem

When a defect factor is identified for equipment such as manufacturing devices, elevators, air conditioners, and power plant equipment, correlation analysis is applied to sensor data in the conventional method. In addition to sensor data, devices have device setting values, device information such as models and model numbers, and category data which is information such as OK/NG determination as to whether the device properly operates. Although there is a possibility that a defect appears only in the category data, which is out of the scope of correlation analysis in the conventional method. Thus, there is a problem that defects appearing only in category data cannot be detected. For example, in the case of a defect that the room temperature deviates largely from a set temperature in an air conditioner, although the defect cannot be detected from the correlation between values measured from sensor data (power consumption, room temperature, etc.), the defect can be easily detected from the correlation between the set temperature and the room temperature.

The present invention has been devised to solve the above problem, and it is an object of the present invention to detect a defect that cannot be detected by the conventional technology by utilizing category data.

### Solution to Problem

A defect factor estimation device according to the present invention includes: a data collecting unit for collecting category data of a device included in equipment; a correlation calculating unit for calculating a correlation index of data including the category data collected by the data collecting unit; a data extracting unit for extracting a combination of data including the category data as a data item related to a defect on the basis of a change in the correlation index calculated by the correlation calculating unit; and a causal relationship estimating unit for extracting a data item estimated to be a defect factor from among data items related to the data item related to the defect.

### Advantageous Effects of Invention

According to the present invention, utilizing category data enables detection of defects which cannot be detected by the conventional technology.

### BRIEF DESCRIPTION OF DRAWINGS

FIG. 1 is a diagram illustrating a configuration of a defect factor estimation device 1 according to a first embodiment of the invention.

FIG. 2 is an example of data items of category data according to the first embodiment of the present invention.

FIG. 3 is an example of data items of sensor data according to the first embodiment of the present invention.

FIG. 4 is exemplary processing of data in the defect factor estimation device 1 according to the first embodiment of the present invention.

FIG. 5 is a flowchart illustrating processing in the defect factor estimation device 1 according to the first embodiment of the present invention.

FIG. 6 is a hardware configuration example of the defect factor estimation device 1 according to the first embodiment of the present invention.

FIG. 7 is a configuration example of a defect factor estimation device 1 according to a second embodiment of the present invention.

FIG. 8 is a configuration example of a defect factor estimation device 1 according to a third embodiment of the present invention.

FIG. 9 is a configuration example of a defect factor estimation device 1 according to a fourth embodiment of the present invention.

### DESCRIPTION OF EMBODIMENTS

### First Embodiment

An embodiment of the present invention will be described below.

In the present embodiment and the following embodiments, a defect factor estimation device and a defect factor estimation method utilizing category data will be described.

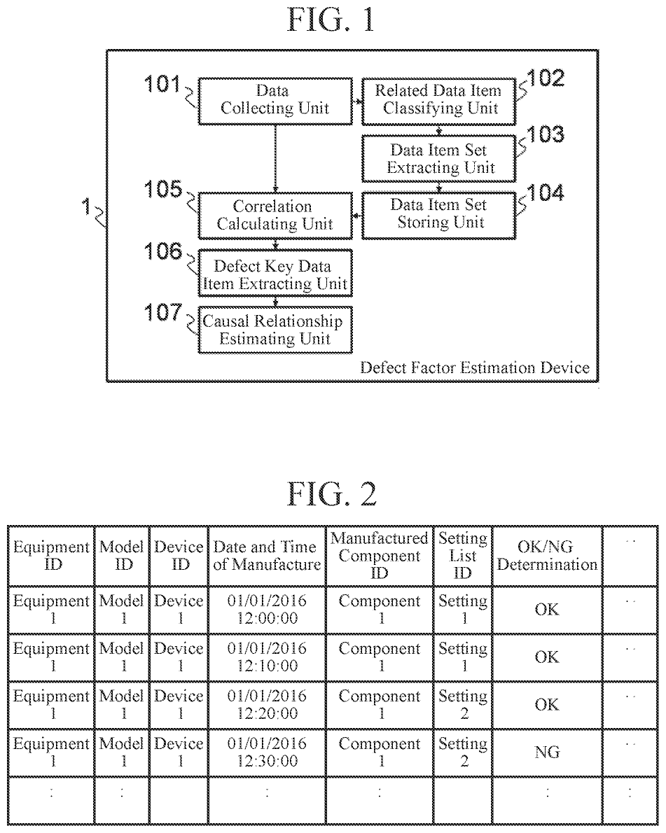

FIG. 1 is a diagram illustrating a configuration example of a defect factor estimation device 1 used in the present invention. The defect factor estimation device 1 includes a data collecting unit 101, a related data item classifying unit 102, a data item set extracting unit 103, a data item set storing unit 104, a correlation calculating unit 105, a defect key data item extracting unit 106, and a causal relationship estimating unit 107. In the following drawings, the same symbols indicate the same or corresponding components.

The data collecting unit 101 collects and accumulates device setting values, device information such as models and model numbers, and category data information such as OK/NG determination as to whether the device properly operates. A sensor is installed in a device, and in the case where sensor data can also be collected, sensor data may also be collected and accumulated as well. The OK/NG determination as to whether the device has properly operated or similar determination may be determined from the sensor data and setting values, and the data collecting unit 101 may collect and accumulate one of or both of the sensor data and the setting values.

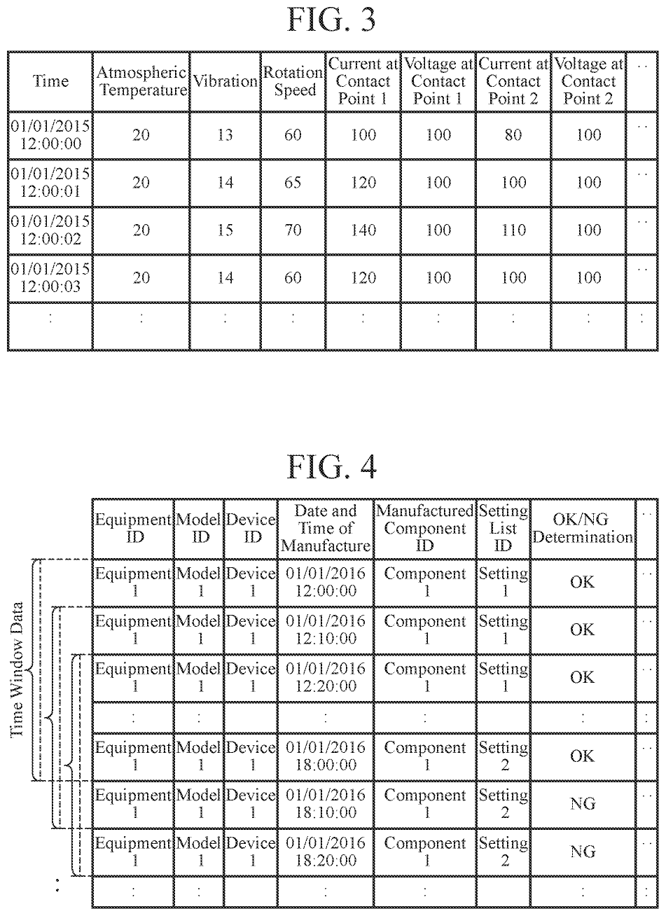

Let us look at an example of a manufacturing device with exemplary category data illustrated in FIG. 2 and exemplary sensor data illustrated in FIG. 3. In this example, the category data includes a nominal scale for assigning numerical values as reference numbers (for example, model identifier (ID)) simply for the purpose of classification as well as an ordinal scale in which numerical values are assigned and orders of the numerical values are meaningful but intervals between the numerical values are meaningless.

In FIG. 2, as an example of data items of category data collected by the data collecting unit 101, the equipment ID, the model ID, the device ID, the date and time of manufacture, the manufactured component ID, the setting list ID, OK/NG determination, etc. are illustrated. Values in FIG. 2 are an example. The data items can be modified since the data items store items of category data collected from actual equipment or a device. As far as a plurality of pieces of equipment or a plurality of devices can be distinguished from each other, data of the plurality of pieces of equipment or the plurality of devices can be aggregated into a single table. As long as the same equipment or the same device can be associated therewith, data of the same equipment or the same device may be divided into a plurality of tables.

In FIG. 3, as an example of data items of sensor data, the air temperature, vibration, the rotation speed, the current at a contact point 1, the voltage at the contact point 1, the current at a contact point 2, the voltage at the contact point 2, etc. are illustrated. Values in FIG. 3 are an example. The data items can be modified since the data items store items of sensor data collected from actual equipment or a device. As far as a plurality of pieces of equipment or a plurality of devices can be distinguished from each other, data of the plurality of pieces of equipment or the plurality of devices can be aggregated into a single table. As long as the same device can be associated therewith, data of the same equipment or the same device may be divided into a plurality of tables. Data items shared by some devices such as the atmospheric temperature and the humidity may be managed by a table other than that of data of the devices.

The related data item classifying unit 102 classifies, for each relevant data item, the data items collected by the data collecting unit 101. The classification of data items may be performed by a general clustering method such as the nearest neighbor algorithm or the k-means clustering. It is also possible to use a classification method in which highly correlated items are classified into the same category by a general correlation analysis method such as the Cramer's coefficient of association or the Spearman's rank correlation coefficient. Relevant data items may be given with a classification index from the perspective of the structure of the device or the meaning of the data items. By classifying the data items into relevant data items, it is expected to reduce the influence of false correlation in calculation of correlation.

The data item set extracting unit 103 extracts a combination of correlated data items (hereinafter referred to as a data item set) for each category classified by the related data item classifying unit 102. As a correlation index, by using a general correlation analysis method such as the Spearman's rank correlation coefficient or the Cramer's coefficient of association, a data item set having a large correlation coefficient or a large coefficient of association may be extracted. Relevant data item sets may be extracted from the perspective of the structure of the device or the meaning of the data items, and a data item may be designated by a set or by the data item itself.

In the data item set storing unit 104, for each data item set extracted by the data item set extracting unit 103, the name, the ID, and the like that can identify the data items and the name, the ID, and the like that can identify the classifications by the related data item classifying unit 102 are stored. Values of the correlation index calculated by the data item set extracting unit 103 may also be stored.

By processing from the related data item classifying unit 102 to the data item set storing unit 104, a combination of correlated data items can be extracted from among a large number of combinations. In addition, the correlation calculating unit 105 can efficiently analyze the correlation by calculating the correlation only for the extracted data items.

The correlation calculating unit 105 calculates an index of correlation for data (hereinafter referred to as time window data) obtained by dividing the category data collected by the data collecting unit 101 by a constant time width (hereinafter referred to as time window), for each of the data item sets stored in the data item set storing unit 104. As an index of correlation (hereinafter referred to correlation index), a general correlation analysis method such as the Spearman's rank correlation coefficient or the Cramer's coefficient of association is used. Here, modifying the correlation index depending on the scale of a data item set may improve the accuracy representing the correlation. As a general definition, the scale of category data includes ordinal scales and nominal scales. Examples of selection of a correlation index depending on the scale of a data item set includes selecting the Spearman's rank correlation coefficient when both data items in the data item set are ordinal scales, selecting the Cramer's coefficient of association when the both are nominal scales, and selecting a rank correlation ratio when an ordinal scale and a nominal scale are combined. An index representing general correlation other than the above may be used alternatively. A single type of correlation index may be applied to all data items without using different indices. An example of a method for extracting time window data for calculating correlation from the category data is illustrated in FIG. 4.

Illustrated in FIG. 4 is an example in which a time window for extraction from the category data is slid by one row to extract as time window data. The slide width and the time window width may be set in any manner. The time windows do not necessarily overlap. The time window does not necessarily have a constant width, such as dividing into a period during which no defect has occurred and a period for which a defect factor is to be estimated.

The defect key data item extracting unit 106 detects a data item a correlation index value of which calculated by the correlation calculating unit 105 has changed, as a data item that is a key to a defect (hereinafter referred to as a defect key data item). Basically, the reason why a correlation index value changes over time is because some problem has occurred, and thus this defect is detected. One object here is to detect weaker correlation of a data item set that normally has a strong correlation. As a method to satisfy this object, a decrease in a correlation index value with elapse of time is detected. As a threshold value for determining the decrease, any value can be set individually for each data item set or collectively for all data item sets. Another object is to detect a change in the correlation compared to a usual state, in a case where strong correlation is not necessarily present usually, for example, the data item set extracting unit 103 extracts a related data item set from the perspective of a configuration of the device or the meaning of data items As a method to satisfy this object, an increase or a decrease in a correlation index value with elapse of time is detected. As a threshold value for determining the increase or the decrease, any value can be set individually for each data item set or collectively for all data item sets. When a plurality of data item sets is detected, the data item set first detected is used as the defect key data item.

The causal relationship estimating unit 107 searches for a data item (hereinafter referred to as related data item) related to the defect key data item extracted by the defect key data item extracting unit 106 and extracts as a data item (hereinafter referred to as defect factor data item) which may be the defect factor. The search range is within the same category as the defect key data item out of the categories classified by the related data item classifying unit 102. However, other categories can also be included in the search range. With regard to the relevance with the defect key data item, data items of a data item set which has not been extracted by the defect key data item extracting unit 106 but a correlation index value of which has changed over time, is detected as related data items. As a threshold value for determining the change in the correlation index value, any value can be set individually for each data item set or collectively for all data item sets. However, since the data item set has not been extracted by the defect key data item extracting unit 106, the threshold value for detecting a decrease in the correlation index value is set to be larger than the threshold value in the defect key data item extracting unit 106, and the threshold value for detecting an increase in the correlation index value is set to be smaller than the threshold value in the defect key data item extracting unit 106. As estimation of causal relationship, the defect key data item may be regarded as a result while the related data items may be regarded as factors. In a case where a plurality of related data items is detected, the causal relationship may be continued in the order of detection with a related data item detected later regarded as a result and a data item detected earlier regarded as a factor. The causal relationship may be listed from the perspective of a configuration of the device or the meaning of data items, and the list of causal relationships corresponding to the defect key data item may be quoted. The defect key data item and the extracted related data items are defined as defect factor data items. From the causal relationship of the defect factor data items, a defect factor data item detected as an overall factor may be estimated to have the highest probability as the defect factor. A change rate in the correlation index value may be defined for each of the defect factor data items, and a defect factor data item having the largest change rate may be estimated to have the highest probability as the defect factor.

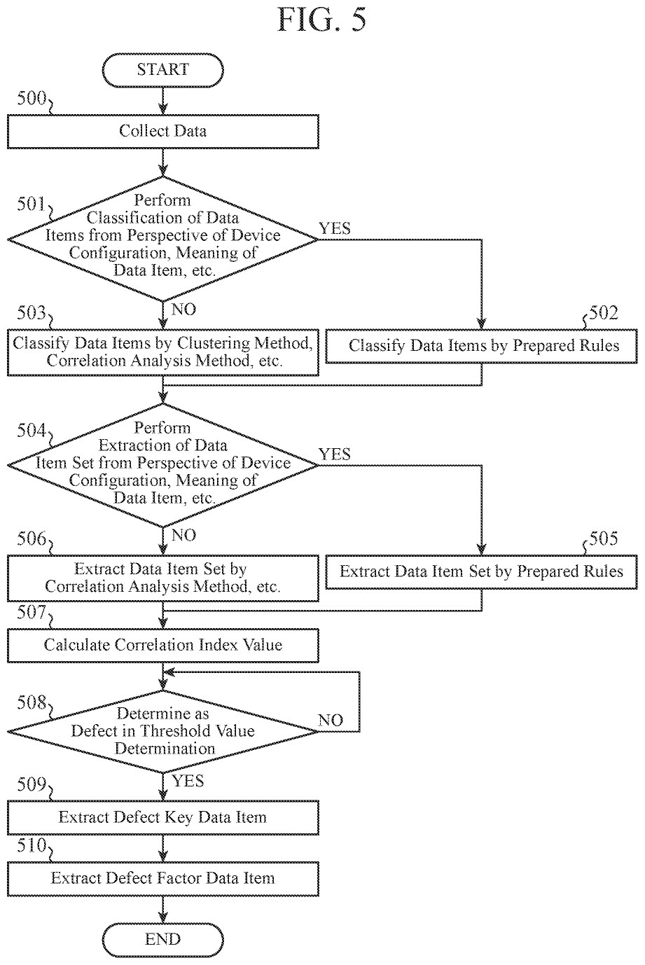

Illustrated in FIG. 5 is an exemplary processing flow of the defect factor estimation device 1. First, the data collecting unit 101 collects data (500), and then the related data item classifying unit 102 selects a method for classifying data items (501). If classification is performed from the perspective of the configuration of the device or the meaning of the data items, the data items are classified according to prepared rules (502). If the rules are not used, the data items are classified using a clustering method, a correlation analysis method, or the like (503). Upon completion of 502 or 503, the data item set extracting unit 103 selects a method of extracting a data item set (504). If extraction is performed from the perspective of the configuration of the device or the meaning of the data items, the data items are extracted according to prepared rules (505). If the rules are not used, a data item set is extracted by prepared rules (506). In the processing in the correlation calculating unit 105, a correlation index value is calculated from the time window data by using a correlation analysis method (507). In the processing in the defect key data item extracting unit 106, it is determined whether the threshold value for extracting the defect key data item has been exceeded (508). If exceeded, a defect key data item is extracted (509). If it is not exceeded, determination by a next correlation index value is performed in 508. Upon completion of 509, the causal relationship estimating unit 107 extracts a related data item related to the defect key data item and extracts a defect factor data item (510).

Note that although a combinations of correlated data items is extracted from among many combinations through the processing from the related data item classifying unit 102 to the data item set storing unit 104, in the case where the correlation calculated by the correlation calculating unit 105 is predetermined, it is not necessary to extract data items through the processing from the related data item classifying unit 102 to the data item set storing unit 104. In this case, the correlation calculating unit 105 calculates the correlation for the predetermined data item.

One application of the present invention is use for a manufacturing device. In a manufacturing device, even in a case where the same equipment is used, in some cases the ratio of defective products changes depending on manufactured products, setting values, external environment, etc. For example, when a component 1 is manufactured, let us assume that the defect rate is about 0.1% in both cases of manufacturing with setting 1 and setting 2 to a certain timing T1. There are cases in which, at a timing T2 one year later, the defect rate increases to about 1% in the case of manufacturing with setting 2 even though the defect rate has been about 0.1% in the case of manufacturing with setting 1. In this case, it can be said that the setting 1 is more suitable for manufacturing the component 1 since the defect rate of the setting 1 is lower than that of the setting 2 under production conditions after one year. In this case, by applying the present invention, in the case where the settings and conforming product/defective product are applied as a data item set to the manufacturing data of the component 1, though there is no correlation in the data item set at the certain timing T1, since the correlation becomes strong after the timing T2 after one year, the corresponding setting can be extracted as a defect factor.

Note that since correlation analysis is performed in the conventional technology using sensor data, it is not enabled to detect the fact that a defect occurs only with setting in which a specific model or a specific device as category data is combined. On the other hand, according to the present invention, it is enabled to grasp that a defect occurs with setting in which a specific model or a specific device is combined and to detect defects which cannot be detected in the conventional technology.

Moreover, in the first embodiment, for example, when the defect rate of a product changes in the manufacturing device, a data item which may be a defect factor can be detected, and a data item having a high probability as a factor can be further extracted from among the extracted data items. Furthermore, even in a case where it is unknown which data item is to be noted, the corresponding data item can be automatically extracted from the correlation of the original data items.

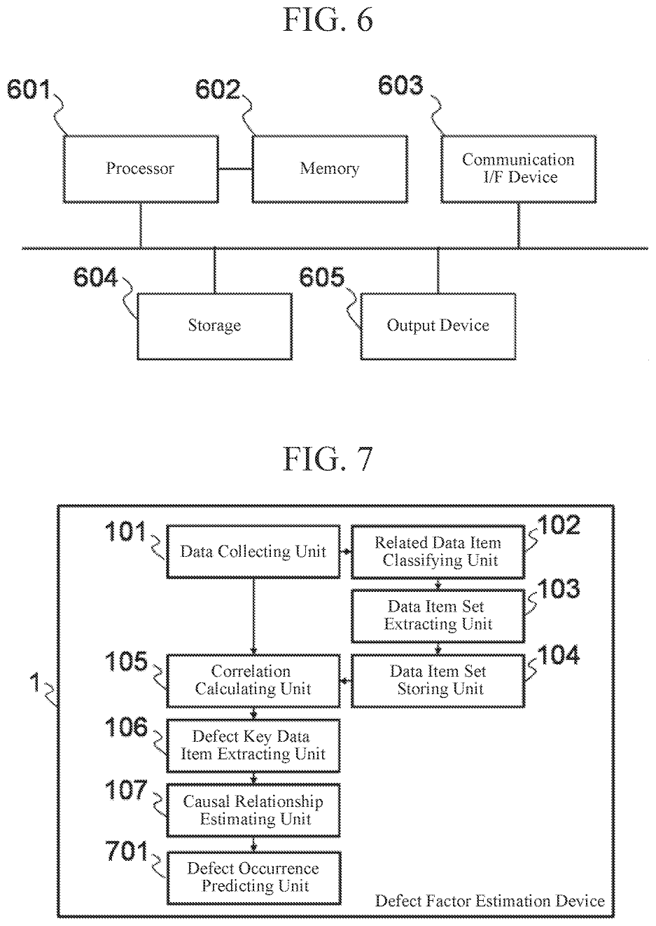

Illustrated in FIG. 6 is a hardware configuration example in the case of the defect factor estimation device 1 of FIG. 1. Data collected by the data collecting unit 101, data stored in the data item set storing unit 104, and calculation results by the causal relationship estimating unit 107 are stored in a storage 604. Results calculated by the related data item classifying unit 102, the correlation calculating unit 105, and the defect key data item extracting unit 106 may also be stored in the storage 604. The processing performed by the related data item classifying unit 102, the data item set extracting unit 103, the correlation calculating unit 105, the defect key data item extracting unit 106, and the causal relationship estimating unit 107 is executed by a processor 601 reading out programs stored in a memory 602. The rules of data items referred to by the related data item classifying unit 102 and the data item set extracting unit 103 may be read from data stored in the storage 604 or may be acquired through a communication interface (I/F) device 603. An output result of the causal relationship estimating unit 107 is output by an output device 605 as necessary. Note that a group of the data collecting unit 101, the correlation calculating unit 105, the defect key data item extracting unit 106, and the causal relationship estimating unit 107, and a group of the related data item classifying unit 102, the data item set extracting unit 103, and the data item set storing unit 104 may be configured on different pieces of hardware and communication between the pieces of hardware may be performed by the communication I/F device 603 as necessary.

As described above, the defect factor estimation device 1 according to the first embodiment includes: the data collecting unit 101 for collecting category data of a device included in equipment; the correlation calculating unit 105 for calculating a correlation index of data including the category data collected by the data collecting unit 101; the defect key data item extracting unit 106 which is the data extracting unit for extracting a combination of data including the category data as data related to a defect on the basis of a change in the correlation index calculated by the correlation calculating unit 105; and the causal relationship estimating unit 107 for extracting data estimated to be a defect factor from data related to the data related to the defect. With this configuration, utilizing category data enables detection of defects which cannot be detected by the conventional technology.

Moreover, in the defect factor estimation device 1 according to the first embodiment, the data including the category data is a data item including the category data, the data related to the defect is a data item related to the defect, the related data is a related data item, and the data estimated to be the defect factor is a data item estimated to be the defect factor. With this configuration, performing the correlation analysis for each data item enables efficient data processing and detection of defects that cannot be detected by the conventional technology.

In the defect factor estimation device 1 according to the first embodiment, the data collecting unit 101 collects sensor data measured by a sensor installed in the device together with the category data of the device, and the correlation calculating unit 105 calculates a correlation index of data including the category data and the sensor data collected by the data collecting unit. With this configuration, defects which cannot be detected by the conventional technology can be detected, and the accuracy of defect detection and factor estimation can be improved compared with the conventional technology.

Furthermore, in the defect factor estimation device 1 according to the first embodiment, the equipment includes a manufacturing device, an elevator, an air conditioner, or a power plant equipment. With this configuration, defects that cannot be detected by the conventional technology can be detected in manufacturing devices, elevators, air conditioners, or power plant equipment

In the defect factor estimation device 1 according to the first embodiment, the category data includes a setting value for operation of the device, environmental data of the device, or an operation determination result of the device such as OK/NG. With this configuration, defects occurring in relation to a setting value for operation of the device, environmental data of the device, or an operation determination result of the device such as OK/NG can be detected.

### Second Embodiment

In a second embodiment, a configuration in which a defect occurrence predicting unit is further added to the configuration of the first embodiment will be described.

Illustrated in FIG. 7 is a configuration example of a defect factor estimation device 1 according to the second embodiment. In the present embodiment, after the causal relationship estimating unit 107 of the first embodiment, a defect occurrence predicting unit 701 performs processing of defect occurrence prediction. In defect occurrence prediction, a timing (hereinafter referred to as defect timing) when a defect is likely to occur next time or when the number of defects are likely to increase is predicted from the past defect occurrence rate of the defect factor data item. Not only the defect timing is predicted, but also the defect rate may be predicted for each time period to elapse in the future.

As a specific example, when the setting 2 is extracted as the defect factor data item by the causal relationship estimating unit 107 on the basis of past data, a defect occurrence rate of 0.1% from the time point of the extraction to the timing T1 and a defect occurrence rate of 1% to the timing T2 are recorded as statistical data. When the setting 2 is extracted as the defect factor data item by the causal relationship estimating unit 107 this time, a defect occurrence rate of 0.1% to the timing T1 and a defect occurrence rate of 1% to the timing T2 are predicted on the basis of the statistical data. It can be also predicted that a timing when the number of defects is likely to increase is between the timing T1 and the timing T2.

Note that in the case where the defect occurrence prediction is performed only by an unnecessary key data item, the causal relationship estimating unit 107 may be omitted. According to the second embodiment, not only the factor of the defect but also the defect timing becomes known, a planned countermeasure against the defect factor can be placed.

The hardware configuration in the case of the defect factor estimation device 1 of the present embodiment is similar to that in FIG. 5. In this example, a prediction result of the defect occurrence predicting unit 701 is stored in the storage 604. Also, the processing performed by the defect occurrence predicting unit 701 is executed by the processor 601 reading programs stored in the memory 602.

As described above, the defect factor estimation device 1 according to the second embodiment further includes the defect occurrence predicting unit 701 for estimating the current or future state of defect occurrence on the basis of past defect occurrence information of the data item related to the defect or the data item estimated to be the defect factor. With this configuration, it is possible to estimate the current or the future occurrence state of defects which cannot be detected by the conventional technology.

Furthermore, in the defect factor estimation device 1 according to the second embodiment, the defect occurrence predicting unit 701 predicts a timing of defect occurrence or estimates the current defect occurrence rate on the basis of the past defect occurrence information of the data item related to the defect or the data item estimated to be the defect factor. With this configuration, it is possible to predict the occurrence timing of defects which cannot be detected by the conventional technology. Alternatively, it is possible to estimate the current occurrence rate of defects which cannot be detected by the conventional technology.

### Third Embodiment

In the third embodiment, an embodiment in which correlation analysis is performed also on sensor data in the first embodiment is illustrated.

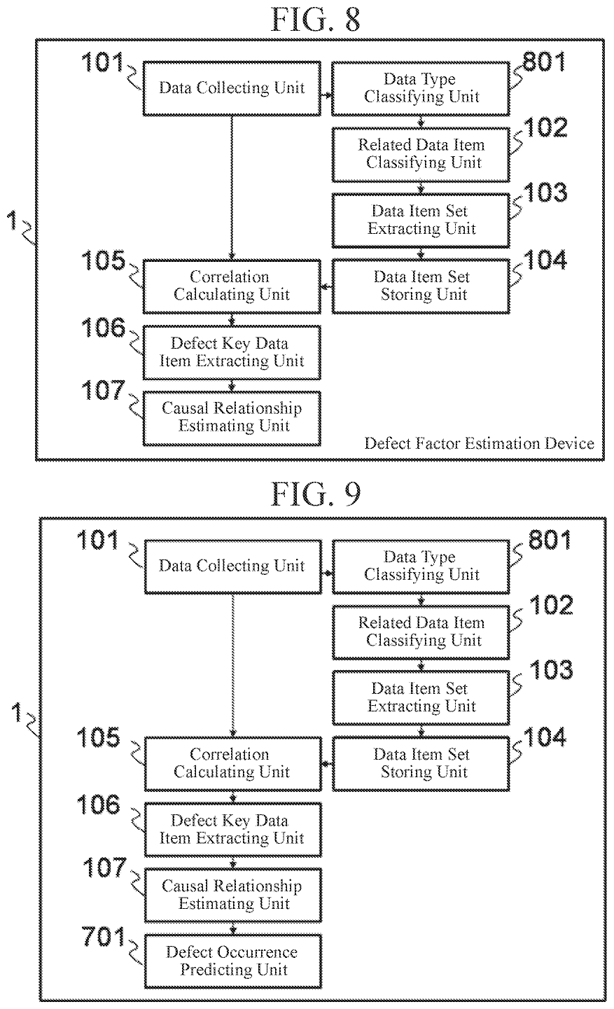

Illustrated in FIG. 8 is a configuration example of a defect factor estimation device 1 according to the present embodiment. In FIG. 8, a data type classifying unit 801 is added following a data collecting unit 101. This is for labeling a data item for the case of modifying a correlation index depending on a combination pattern of category data and sensor data when a correlation calculating unit 105 calculates the correlation index. The labels may include two labels of category data and sensor data. The labels may be four labels of a nominal scale, an ordinal scale, an interval scale, and a ratio scale. In the case where it is assumed that the category data is a nominal scale or an order scale and that the sensor data is an interval scale or a ratio scale, the labels may be three labels of category data, an interval scale, and a ratio scale, or the labels may be three labels of a nominal scale, an ordinal scale, and sensor data.

As an example of modifying the method of calculating correlation for each label of a data item in the correlation calculating unit 105, the following three patterns are illustrated depending on a label of a data item. A first pattern: a case where both in a data item set are category data, the Spearman's rank correlation coefficient, the Cramer's coefficient of association, or the like is used as a correlation index. A second patter: a case where both in a data item set are sensor data, the Pearson product-moment correlation coefficient or the like is used. A third pattern: a case where a data item set is a combination of category data and sensor data, the Spearman's rank correlation coefficient, a correlation ratio, or the like is used. Instead of modifying the method of calculating correlation for each label, the calculation may be performed by the same method. Category data may be used for data classification, and correlation may be calculated from sensor data. As a method for using category data for data classification, stratification analysis, covariance analysis, and other analysis are available.

Since a change in the correlation of combinations of the category data and the sensor data can be detected according to the third embodiment, many types of defects can be dealt with such as defects appearing only in the category data, defects appearing only in the sensor data, and defects appearing through comparison between the category data and the sensor data.

The hardware configuration in the case of the defect factor estimation device 1 of the present embodiment is similar to that in FIG. 5. In this example, the result calculated by the data type classifying unit 801 is stored in the storage 604. The processing performed by the data type classifying unit 801 is executed by the processor 601 reading programs stored in the memory 602. The rules of data items referred to by the data type classifying unit 801 may be read from data stored in the storage 604 or may be acquired through the communication interface (I/F) device 603.

As described above, the defect factor estimation device 1 according to the third embodiment further includes the data type classifying unit 801 for performing labeling depending on the type of data on the data including the category data and the sensor data collected by the data collecting unit 101, and the correlation calculating unit 105 calculates the correlation index of the data including the category data and the sensor data collected by the data collecting unit, on the basis of a calculation method corresponding to a label attached to the data. This configuration can deal with many types of defects such as defects appearing only in the category data, defects appearing only in the sensor data, and defects appearing through comparison between the category data and the sensor data.

### Fourth Embodiment

In a fourth embodiment, an embodiment for performing, in the third embodiment, the defect occurrence prediction performed in the second embodiment is illustrated.

Illustrated in FIG. 9 is a configuration example of a defect factor estimation device 1 according to the present embodiment. The same components as those in FIGS. 7 and 8 are denoted by the same symbols. According to the fourth embodiment, it is possible to deal with many types of defects such as defects appearing only in the sensor data and defects appearing through comparison between the category data and the sensor data, and prediction of a defect timing and estimation of a defect rate can be performed.

### REFERENCE SIGNS LIST

1: defect factor estimation device, 101: data collecting unit, 102: related data item classifying unit, 103: data item set extracting unit, 104: data item set storing unit, 105: correlation calculating unit, 106: defect key data item extracting unit, 107: causal relationship estimating unit, 601: processor, 602: memory, 603: communication I/F device, 604: storage, 605: output device, 701: defect occurrence predicting unit, 801: data type classifying unit

1. A defect factor estimation device comprising:
a processor to execute a program; and
a memory to store the program which, when executed by the processor, performs processes of,
collecting category data of a device included in equipment;
calculating a correlation index of data comprising the category data collected;
extracting a combination of data comprising the category data as data related to a defect on a basis of a change in the correlation index calculated; and
extracting data estimated to be a defect factor from data related to the data related to the defect.

2. The defect factor estimation device according to claim 1,
wherein the data including the category data is a data item including the category data,
the data related to the defect is a data item related to the defect,
the related data is a related data item, and
the data estimated to be the defect factor is a data item estimated to be the defect factor.

3. The defect factor estimation device according to claim 1,
wherein the processes includes collecting sensor data measured by a sensor installed in the device together with the category data of the device, and
calculating a correlation index of data including the category data and the sensor data collected.

4. The defect factor estimation device according to claim 1, wherein the equipment comprises a manufacturing device, an elevator, an air conditioner, or a power plant equipment.

5. The defect factor estimation device according to claim 1, wherein the category data comprises a setting value for operation of the device, environmental data of the device, or an operation determination result of the device.

6. The defect factor estimation device according to claim 1, wherein the processes include:
estimating a current or future state of defect occurrence on a basis of past defect occurrence information of the data related to the defect or the data estimated to be the defect factor.

7. The defect factor estimation device according to claim 6,
wherein the processes includes predicting a timing of defect occurrence or estimates a current defect occurrence rate on a basis of the past defect occurrence information of the data related to the defect or the data estimated to be the defect factor.

8. The defect factor estimation device according to claim 1, wherein the processes include:
performing labeling depending on a type of data on the data comprising the category data and the sensor data collected, and
calculating the correlation index of the data comprising the category data and the sensor data collected, on a basis of a calculation method depending on a label attached to the data.

9. A defect factor estimation method comprising:
collecting category data of a device included in equipment;
calculating a correlation index of data including the category data collected;
extracting a combination of data including the category data as data related to a defect on a basis of a change in the correlation index calculated; and
extracting data estimated to be a defect factor from data related to the data related to the defect.

10. The defect factor estimation method according to claim 9,
wherein the data including the category data is a data item including the category data,
the data related to the defect is a data item related to the defect,
the related data is a related data item, and
the data estimated to be the defect factor is a data item estimated to be the defect factor.
